(19) United States
(12) Patent Application Publication
(10) Pub. No.: US 2011/0206896 A1
(43) Pub. Date: Aug. 25, 2011

(54) Ceramic Honeycomb Body And Process For Manufacture

(76) Inventors: Mark Lee Humphrey, Elmira, NY (US); James Willis Suggs, JR., Horseheads, NY (US)

(21) Appl. No.: 12/712,727

(22) Filed: Feb. 25, 2010

(51) Int. Cl. B32B 3/12; B29C 47/30; H01R 43/00

(52) U.S. Cl. 428/117; 428/116; 425/464; 29/825

(57) ABSTRACT

An extrusion die and method for manufacturing an extrusion die for producing a honeycomb body. The honeycomb body includes a plurality of channels defined by intersecting internal walls. The channels have non-equal cross-sectional sizes arranged in an alternating pattern. The channels are divided into a first region including at least one row of channels adjacent an outer peripheral wall of the body, and a second region including remaining channels. The internal walls in the first region have a thickness that increases along an axis extending to the outer peripheral wall.

### BACKGROUND

This disclosure relates generally to ceramic honeycomb bodies and processes for manufacture of such bodies. More particularly, the disclosure relates to electro discharge machining (EDM) processes for making a honeycomb extrusion die for the manufacture of honeycomb bodies having alternating channel sizes and varying wall thicknesses.

Honeycomb bodies used in catalyst substrate and particulate filtration applications consist of a monolith body having longitudinal, parallel channels defined by longitudinal interconnected webs. The honeycomb bodies are typically made by extruding a plasticized batch material that forms a ceramic material such as cordierite, aluminum titanate or silicon carbide after firing. Extrusion dies used in making the honeycomb bodies have a die body with a discharge end including an array of longitudinal pins defined by interconnected slots. The array of longitudinal pins may include pins having any geometry useful in catalyst substrate and particulate filtration applications, such as rectangular, triangular, or hexagonal. The inlet end of the die body includes feedholes which extend from a base of the die body to the interconnected slots and are used to supply batch material to the slots. To make a honeycomb body using the extrusion die, plasticized batch material is supplied to the feedholes and extruded through the interconnected slots. The batch material extruded through the interconnected slots forms the interconnected webs of the honeycomb body.

In some embodiments, the pins of an extrusion die have a uniform cross-sectional shape and size across the discharge end, while other embodiments employ pins having different cross-sectional shapes or sizes across the discharge end. In some embodiment, the interconnected slots have a uniform width across the discharge end, while other embodiments employ interconnected slots having different or varying widths across the discharge end.

Honeycomb extrusion dies are commonly made using plunge EDM processes. In a typical plunge EDM process, a shaped electrode having the desired pin/slot pattern is closely spaced from a workpiece that will become the extrusion die in a bath of dielectric fluid. The pin/slot pattern is formed in the workpiece by a series of repetitive electrical discharges in the thin gap between the shaped electrode and the workpiece. The electrical discharges generate enough heat to melt the workpiece and transfer the pin/slot pattern of the electrode to the workpiece.

The manufacture of honeycomb structures having varying channel sizes and wall thicknesses presents unique challenges, and innovative processes are needed for the efficient manufacture of such structures.

### SUMMARY

One aspect of the disclosure includes a honeycomb body. In one embodiment described herein, a honeycomb body comprises a plurality of parallel channels defined by intersecting internal walls extending between opposing ends of the honeycomb body. The channels have non-equal cross-sectional sizes arranged in an alternating pattern. An outer peripheral wall surrounds the channels and is interconnected to the internal walls. The channels are divided into a first region including at least one row of the channels adjacent the outer peripheral wall, and a second region including remaining channels. The internal walls in the first region have a thickness that increases along an axis extending to the outer peripheral wall.

A further aspect of the disclosure includes a honeycomb extrusion die. In one embodiment, a honeycomb extrusion die comprises a die body having an inlet face and a discharge face opposite the inlet face. A plurality of feedholes extends from the inlet face into the body, and an intersecting array of discharge slots extend into the body from the discharge face. The array of discharge slots connects with the feed holes at feed hole/slot intersections within the die body. The intersecting array of discharge slots define a plurality of pins of two different cross-sectional areas, the plurality of pins forming a checkerboard matrix of pins alternating in cross-sectional area. A width of the discharge slots increases along an axis extending to an outer periphery of the die.

A further aspect of the disclosure includes a method of manufacturing an extrusion die. In one embodiment, a method of manufacturing an extrusion die comprises providing a die blank and forming a die pattern having a plurality of intersecting discharge slots of uniform width in a face of the die blank by plunging a first EDM electrode into the die blank. The intersecting discharge slots form side surfaces of a plurality of die pins having two different cross-sectional areas, the plurality of die pins forming a checkerboard matrix of pins alternating in size. The die pattern is divided into a first region including the slots and pins adjacent the periphery of the die, and a second region including the remaining slots and pins in the die pattern. The first region of the die pattern is modified by plunging a second EDM electrode into the first region of the die pattern.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The accompanying drawings, described below, illustrate exemplary embodiments of the claimed invention and are not to be considered limiting, for the disclosure describes other equally effective embodiments and features thereof. The figures are not necessarily to scale, and certain features and certain view of the figures may be shown exaggerated in scale or in schematic in the interest of clarity and conciseness.

FIG. 1 is an illustration of a honeycomb article having inlet and outlet channels of alternating size.

FIG. 2 is a greatly enlarged portion of the inlet face of the honeycomb article of FIG. 1, illustrating one embodiment of inlet and outlet channels of alternating size

FIG. 3 is a cross-sectional portion of the honeycomb article of FIG. 1, illustrating the varying (increasing) wall thickness as the walls approach the outer periphery of the honeycomb article.

FIG. 4A schematically depicts a plunge electrode having a plurality of interconnecting webs for forming a die pattern on a workpiece.

FIG. 4B depicts electrode plunge locations forming a die pattern on a workpiece.

FIG. 5 illustrates a cross-section of a portion of an extrusion die.

FIG. 6 schematically illustrates a die modification electrode performing a secondary EDM machining process on an extrusion die.

FIG. 7A schematically illustrates a ¼ pattern die modification electrode performing a secondary EDM machining process on an extrusion die.

FIG. 7B illustrates four different positions occupied by a single ¼ pattern electrode when modifying the entire periphery of a die, with adjacent plunge positions offset from each other for proper alignment with alternating pin sizes.

FIG. 7C shows a greatly enlarged portion of the ¼ pattern die modification electrode of FIG. 7B, illustrating offset of the electrode in adjacent plunge locations.

FIG. 8 illustrates a portion of a die modification electrode for providing increasing wall thickness adjacent the periphery of a honeycomb body.

### DETAILED DESCRIPTION

Reference will now be made in detail to exemplary embodiments which are illustrated in the accompanying drawings. In describing the embodiments, numerous specific details are set forth in order to provide a thorough understanding to the reader. However, it will be apparent to one skilled in the art that some or all of these specific details may not be necessary. In other instances, well-known features and/or process steps have not been described in detail so as not to unnecessarily obscure aspects of the exemplary embodiments. Whenever possible, the same reference numerals will be used throughout the drawings to refer to the same or like parts.

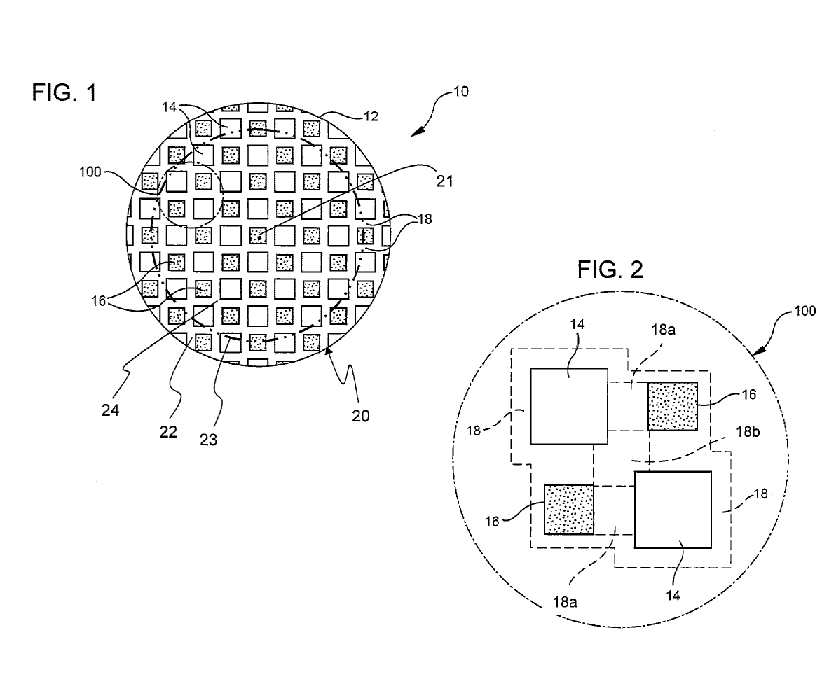

A top view of an end-plugged honeycomb structure with cell channels having two different cross-sectional sizes that provide two different hydraulic diameters is illustrated in FIG. 1. Honeycomb 10 has a front or inlet end 12, and an outlet end (not shown) opposite the inlet end 12. A plurality of cell channels which are divided into inlet cell channels 14 and outlet cell channels 16 extend between the inlet and outlet ends. The cell channels have a generally square cross-section formed by interior porous walls 18. Interior walls 18 extend substantially longitudinally between the inlet and outlet ends of the honeycomb 10. The cell channels 14, 16 are arranged to alternate between inlet cell channels 14 and outlet cell channels 16, resulting in a pattern of alternating cell channels with small and large sizes. In the illustrated embodiment, each inlet cell channel 14 is bordered on all sides by outlet cell channels 16 and vice versa. An outer peripheral wall 20 surrounds the cell channels 14, 16 and interior walls 18. Outer peripheral wall 20 also forms what is commonly referred to as the “skin” of honeycomb 10.

Both inlet cell channels 14 and outlet cell channels 16 are plugged along a portion of their lengths, either at the inlet end 12 or the outlet end. In FIGS. 1 and 2, inlet end 12 is illustrated, so plugged outlet cell channels 16 are seen. That is, inlet cell channels 14 are open at the inlet end 12 and plugged at the outlet end. Conversely, outlet cell channels 16 are plugged at the inlet end 12 and open at the outlet end. This “checkerboard” plugging configuration allows more intimate contact between the fluid stream and the porous walls of the structure. The exhaust gas fluid stream flows into the honeycomb 10 through inlet cell channels 14, then through the porous cell walls 18, and out of the honeycomb 10 through the outlet cell channels 16. Of course, different plugging patterns than that shown may be utilized, and in some embodiments, a portion of channels 14, 16 may be completely unobstructed so as to form a partial filter.

FIG. 2 illustrates a close-up view of a small section 100 of FIG. 1 and better shows the structure of the alternating sizes of cell channels 14, 16 in honeycomb 10. A first portion of the interior walls 18 is common to both inlet 14 and outlet 16 cells. This portion depicted by the numeral 18a resides between entire length of outlet cells 16, but only between part of inlet cells 14. Portion 18a of interior wall 18 is preferably filtration active, meaning that in operation engine exhaust gases flow therethrough from the inlet passages 14 to outlet passages 16. The remaining portion 18b of the interior walls 18 engages the section of inlet passages 14 not in communication with outlet passages 16. Interior wall portion 18b may be filtration non-active, meaning that in operation exhaust gases are less likely to flow therethrough from inlet passages 14 to reach outlet passages 16. It is to be noted, however, that some carbonaceous and ash particulates may be captured and collected therein. In one embodiment, the cross-section or hydraulic diameter of inlet cell channels 14 is about 1.1-2.0 times greater than the hydraulic diameter of the outlet cell channels 16. In another embodiment, the cross-section or hydraulic diameter of inlet cell channels 14 is about 1.3-1.6 times greater than the hydraulic diameter of the outlet cell channels 16. In one embodiment, honeycomb 10 has a cell density of about 100-300 cells/in² (15.5-46.5 cells/cm²), although cell densities above and below that range are also contemplated. In one embodiment, honeycomb 10 has a wall thickness about 0.001 to 0.025 inches (0.25-0.64 mm), although wall thicknesses above and below that range are also contemplated. It should be noted that for purposes of illustration, the sizes and proportions of some features of honeycomb 10 as shown in the Figures are greatly exaggerated and not to scale.

Referring again to FIG. 1, a phantom line 23 is drawn as an illustrative example of how cell channels 14, 16 are suitably divided into first region 22 and a second region 24. Specifically, first region 22 comprises cell channels 14, 16 adjacent the outer peripheral wall 20, and second region 24 comprises the remaining cell channels 14, 16 toward the center axis 21. In FIG. 1, the relative scale of features of honeycomb 10 are distorted (specifically the size and number of cell channels 14, 16). However, in one embodiment, first region 22 comprises at least one row of channels 14, 16 adjacent outer peripheral wall 20, although in other embodiments first region 22 may comprise more than four rows, more than seven rows, more than ten rows, or even more than twenty rows adjacent outer peripheral wall 20.

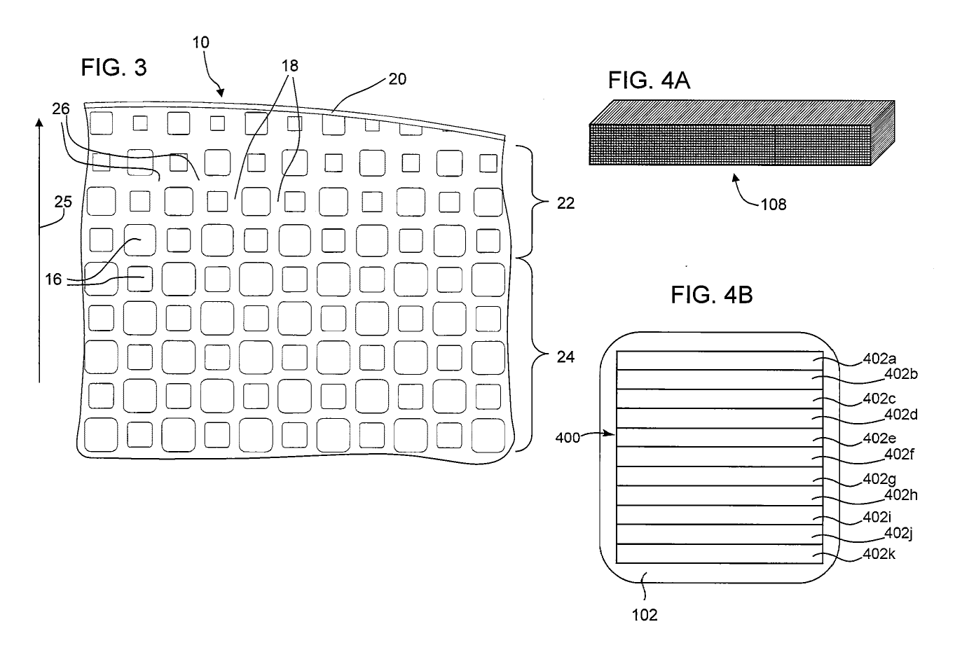

Referring to FIG. 3, a greatly enlarged portion of honeycomb 10 adjacent outer peripheral wall 20 is schematically illustrated. As can be seen in FIG. 3, cells 14, 16 in the first region 22 have a wall thickness which increases along an axis extending toward the outer peripheral wall 20 as indicated by arrow 25, such that interior walls 18 become thicker as they approach outer peripheral wall 20. In one embodiment, the thickness of walls 18 in first region 22 increases to be 1.01 to four (4) or more times the thickness of walls 18 in second region 24, such as near axis 21. It has been found that thickening walls 18 near the outer peripheral wall 20 provides increased isostatic strength to honeycomb 10 without a detrimental effect on the thermal shock resistance of honeycomb 10, and also has a minimum effect on the pressure drop.

In one embodiment, as shown in FIG. 3, fillets 26 are formed in the cell channels 14, 16 at least at junctions or intersections between walls 18 in first region 22. Fillets may also be formed at junctions of walls 18 in second region 24, and at junctions of walls 18 with the outer peripheral wall 20. In one embodiment, fillets at the junctions of walls 18 remain the same in first and second regions 22, 24, although the radius of fillets for cell channels 14 may differ from that of cell channels 16. In another embodiment, fillets closer to the outer peripheral wall 20 may have a radius that is greater than the radius of fillets close to the center axis 21 of the honeycomb 10.

A suitable method for fabricating the honeycomb 10 with alternating channel sizes and wall thicknesses that increase near outer peripheral wall 20 as described above is by forming a plasticized mixture of powdered raw materials which is then extruded through a die into a honeycomb body with alternating cell channel sizes and varying wall thicknesses, then optionally dried, fired and plugged using known apparatuses and processes to form the plugged honeycomb filter. The plugged honeycomb filter is typically mounted (such as on a vehicle) by positioning the filter snugly within a filter enclosure with a refractory resilient mat disposed between the filter sidewall and the wall of the enclosure. The ends of the enclosure may then be provided with inlet and outlet cones for channeling exhaust gas into and through the alternately plugged channels and porous wall of the honeycomb filter.

An extrusion die for fabricating the honeycomb 10 with alternating channel sizes and increasing wall thicknesses near outer peripheral wall 20 as described above will have a corresponding pin array comprising pins of alternating size separated by discharge slots, where the discharge slots gradually widen in a direction along an axis extending to the outer periphery of the die. One method for fabricating such a die is a plunge EDM process.

Referring to FIGS. 4A and 4B, in a plunge EDM process, a shaped electrode 108 having a pattern of features is used for machining those features into a workpiece 102 (sometimes referred to as a die blank) that will eventually become the die. A suitable electrical discharge electrode 108 for carrying out the plunge EDM method can be formed from a copper-tungsten alloy blank using traveling wire electrical discharge machining (wire EDM), as known in the art. Other suitable materials for electrode 108 include silver-tungsten, graphite, and copper-graphite, for example. In use, the electrode 108 is positioned close to the workpiece 102, and features of the electrode 108 are machined into the workpiece 102 through repetitive electrical charges discharged into a gap between the electrode 108 and the workpiece 102. For example, as shown in FIG. 4A, for a honeycomb extrusion die having a lattice of interconnected webs, the shaped electrode 108 includes a lattice of interconnected webs forming a honeycomb pattern or a portion of a honeycomb pattern. The shaped electrode 108 is configured to form multiple features (e.g., multiple rows and columns of pins and slots) at a time. In general, the shaped electrode 108 may be configured to form patterns with features of any desired shape. In one example, the pattern to be formed in workpiece 102 by electrode 108 is an array of alternating size pins separated by slots of uniform width.

In FIGS. 4A and 4B, the electrode 108 is illustrated as having an overall rectangular shape corresponding to a rectangular shape that is some fraction of the full die pattern 400 (FIG. 4B). Depending on the final die size, the width of the electrode 108 may correspond to the full width of the die pattern 400, one half the width of the die pattern, or some smaller fraction. FIG. 4B illustrates a full die pattern 400 on workpiece 102, with plunge locations 402a-402k (collectively plunge locations 402) on the workpiece 102. There are eleven plunge locations 402 illustrated in FIG. 4B, but any other number of plunge locations 402 may be used. The number of plunge locations 402 will depend, for example, on the size of the full die pattern 400 and the size of electrode 108.

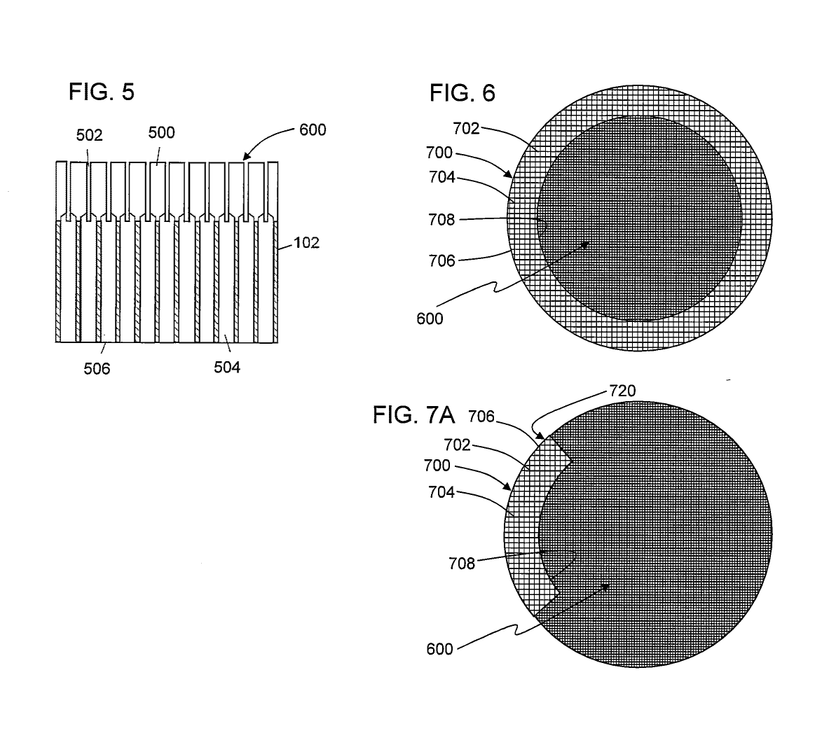

FIG. 5 shows an exemplary illustration of a cross-section of the workpiece 102 after forming pins 500 and slots 502 in the workpiece 102 using a plunge EDM process as described above. To complete formation of an extrusion die, feedholes 504 can be formed in the workpiece 102, and the final die 600 may be cut from the workpiece in any desired shape (e.g., circular, oval, rectangular, etc.). A circular die 600 cut from workpiece 102 is illustrated in FIG. 6. The feedholes 504 would typically extend from the base 506 of the workpiece 102 to the slots 502 in order to allow plasticized batch material to be supplied to the slots 502 and extruded therethrough. The workpiece 102 with the pins 500, slots 502, and feedholes 504 may serve as a template for other honeycomb extrusion dies. For example, the pins 500 may be modified as necessary to achieve other geometries more suitable for a particular application.

The EDM die manufacturing process described above provides a die with a pin array having discharge slots with a uniform width across the discharge face of the die. Therefore, to provide honeycomb 10 with walls 18 having increasing thickness as they approach outer peripheral wall 20, there is a need to further modify the widths of discharge slots 502 in the die at locations corresponding to second region 24 of honeycomb 10. Such modification may be accomplished with a die modification electrode 700 performing a secondary die modification plunge EDM process.

Since the only a portion of the discharge slots 502 (i.e., those corresponding to second region 24) require modification, a die modification electrode 700 used in a secondary plunge EDM process need only encompass that area of the die where the modifications are to occur. Specifically, widening the discharge slots 502 adjacent the outer periphery of the die requires that a plurality of pins in the second region 24 of the die (adjacent outer peripheral wall 20) be further machined by the die modification electrode.

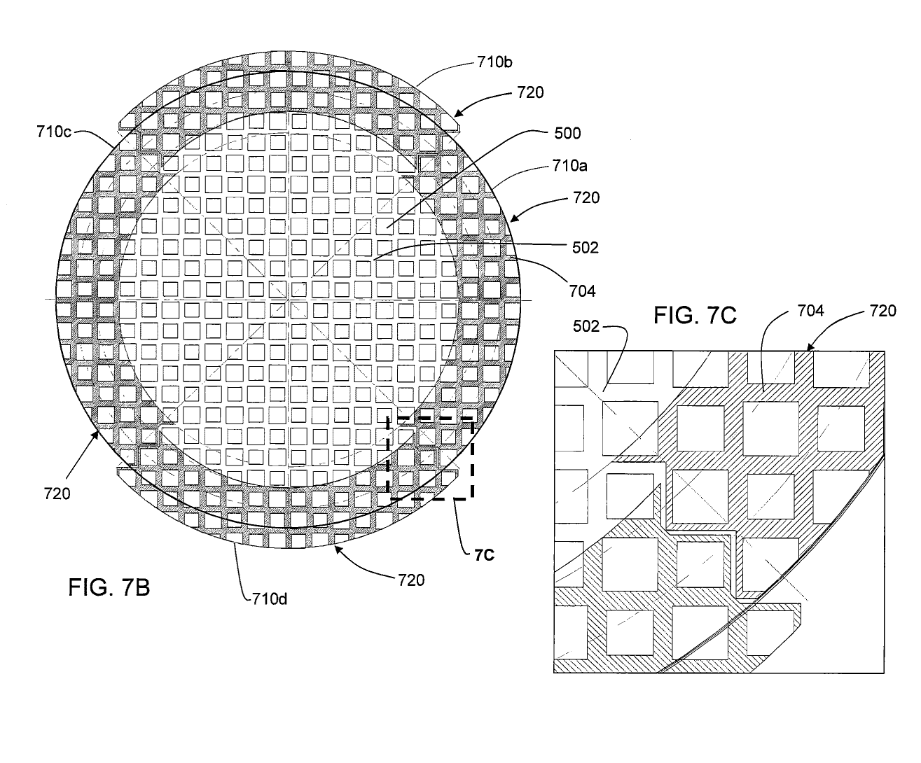

FIGS. 6 and 7A schematically shows a die 600 and embodiments of a die modification electrode 700 in accordance with the present disclosure. Die 600 comprises pins 500 and discharge slots 502 previously machined by shaped electrode 108. Die modification electrode 700 includes openings 702 formed by a network of intersecting webs 704. Webs 704 have an increasing width as they approach the outer edge 706 of electrode 700, which stands opposite inner edge 708 of electrode 700. The width of webs 704 is increased from the nominal (original) thickness of discharge slots 502 to the desired thickness at the periphery of the die 600 in either a continuous or a stepped manner. For example, in one embodiment, the width of webs 704 (and also the width of corresponding slots 502) is increased at each subsequent pin location by a predetermined amount (e.g., 0.5 mil, 0.75 mil, 1 mil, or any other selected amount). In one embodiment, the increase in width becomes larger as the web 704 reaches the outer edge 706 of electrode 700. For example, if electrode 700 is configured to modify 10 rows of pins 500, the width of web 704 may be increased by 0.5 mils for each of the first 4 pins, 0.75 mils for each of the next 4 pins, and 1 mil for the final 2 pins. Of course, a limitless number of other such examples with different distances and pin numbers can be constructed.

During the die modification plunge EDM process, die 600 is held stationary while electrode 700 is lowered on the array of pins 500. When electrode 700 is lowered into the array of pins 500, the webs 704 being thicker than pre-existing slots 502 remove material from all side surfaces of pins 500. If the corners of intersecting webs 704 are filleted, material will also be removed from the corners of pins 500. As a result, pre-existing slots 502 are machined to become wider by narrowing surrounding pins 500. If so provided, the filleted corners of webs 704 radius the corners of pins 500 to create fillets in the extruded honeycomb. Depending on the number of pin rows requiring modification, the size of electrode 700, along with the number of openings 702 and thickness of webs 704 is varied accordingly.

The die modification plunge EDM process does not alter the inlet or feedhole section of the die 600 in any way, nor is there any change to the inlet section of the die required. The geometry of the extruded honeycomb 10 produced from a machined die of this design has alternating channel sizes with continuously thickening walls in a region of cells adjacent an outer peripheral wall 20 of the honeycomb 10.

In the embodiment of FIG. 6, die modification electrode 700 comprises a single structure that circumscribes the entire periphery of die 600. However, one skilled in the art can appreciate the complexity and high cost in fabricating such an electrode due to the many precision machining steps required. Creating a unitary electrode encompassing the entire 360° pattern may be excessively costly, and include risks of high variability and risk of scrapping due to unforeseen upsets during the electrode manufacturing process, such as tool breakage, power failures, etc., as well as human error.

For these reasons, in another embodiment as illustrated in FIGS. 7A through 7C, die modification electrode 700 comprises a ¼ pattern electrode 720 (i.e., electrode 720 circumscribes a 90° arc about the periphery of die 600) that is plunged, retracted, rotated and plunged again until the entire periphery of die 600 has been machined. The ¼ pattern die modification electrode 720 is a cost-effective solution to the issues mentioned above.

However, because of the alternating pin sizes of die 600, a ¼ pattern electrode/four rotation plunge EDM die modification process presents a unique challenge in aligning the alternating sizes of the openings in the ¼ pattern die modification electrode 720 with the alternating sizes of pins 500 when moving from one plunge location to the next. Specifically, the alternating large channel/small channel pattern of die 600 causes misalignment with the ¼ pattern electrode 720 at the plunge intersections if the electrode 720 is simply rotated 90° to the next plunge location. That is, a ¼ pattern electrode 720 for machining alternating pin sizes will only properly align if it is rotated 180° (thus skipping a 90° arc therebetween). One option for solving this problem is through the use of two different ¼ pattern electrodes, where the two different electrodes are shaped to cover two opposing 90° arcs of the die periphery. While the use of two unique ¼ pattern electrodes will solve the alignment problem, that solution adds the complexity and cost of: 1) fabricating a second electrode; and 2) increased processing time due to additional tooling changeover and setup required for the second ¼ pattern electrode. The additional steps also provide increased opportunity for error to be introduced into the process.

Accordingly, this disclosure provides a solution to the above-described die modification electrode alignment issue and enables the use of a single ¼ pattern electrode 720. Proper alignment between the ¼ pattern electrode 720 and the die 600 is accomplished by offsetting the location of the ¼ pattern electrode 720 when positioning for the next plunge location. Referring to FIGS. 7B and 7C, one possible example of such offsetting is shown. Specifically, the electrode 720 is moved in or out by one or more rows from adjacent plunge locations 710a, 710b, 710c and 710d, such that the webs 704 of electrode 720 align with the discharge slots 502 of die 600. In one embodiment, as shown in FIGS. 7A-7C, plunge locations 710a, 710b, 710c and 710d are located such that ends of the ¼ pattern electrode 720 are positioned at 45° angles with respect to the orientation of the pins 500 and slots 502 of die 600. The offset between adjacent plunge locations enables the use the same ¼ pattern electrode 720 for all four locations 710a, 710b, 710c, 710d. As seen in FIG. 7C, the ends of electrode 720 are provided with a “zig-zag” shape such that matching to adjacent plunge locations is provided.

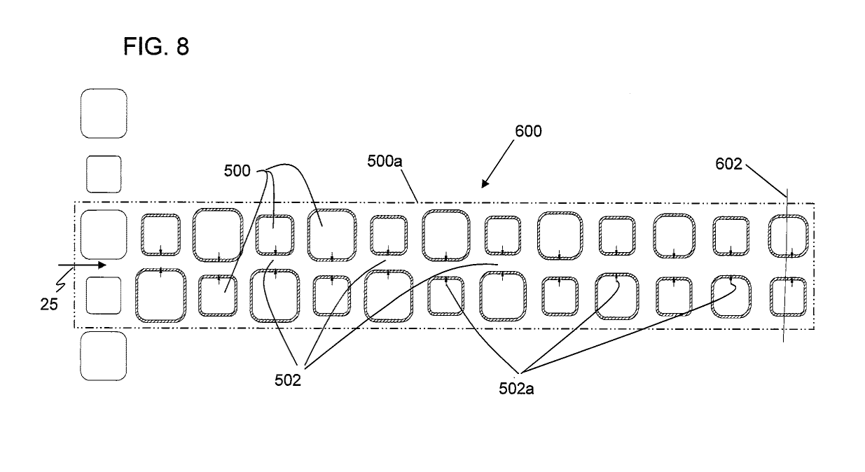

To modify pins 500, die modification electrode 700/720 is used to remove material from the sides of the pins 500. FIG. 8 shows a portion of a die 600 in which a plurality of pins 500 (inside the dashed box 500a) have been machined according to the die modification plunge EDM process and die modification electrode 700 described herein. The modified pins 500 have a smaller size, which results in increasingly wider discharge slots 502 as shown at the arrows designated by reference numeral 502a. Discharge slots 502 gradually widen in a direction along axis 25 extending to the outer periphery of the die 600 (designated by line 602).

While the claimed invention has been described herein with respect to a limited number of embodiments, those skilled in the art, having benefit of this disclosure, will appreciate that other embodiments can be devised which do not depart from the scope of the invention as claimed herein. Accordingly, the scope of the invention should be limited only by the attached claims.

What is claimed is:

1. A honeycomb body comprising:
a plurality of parallel channels defined by intersecting internal walls extending between opposing ends of the honeycomb body, wherein the channels have non-equal cross-sectional sizes arranged in an alternating pattern; and
an outer peripheral wall surrounding the channels and further being interconnected to the internal walls;
wherein the channels are divided into a first region including at least one row of the channels adjacent the outer peripheral wall, and a second region including remaining channels; and
wherein the internal walls in the first region have a thickness that increases along an axis extending to the outer peripheral wall.

2. The honeycomb body of claim 1, wherein the first region includes at least four rows of channels adjacent the outer peripheral wall.

3. The honeycomb of claim 1, wherein the internal walls in the first region have a thickness that is 1.01 to 4 times the thickness of internal walls in the second region.

4. The honeycomb body of claim 1, wherein the channels include inlet channels having a first cross-sectional area and outlet channels having a second cross-sectional area, wherein the second cross-sectional area is smaller than the first cross-sectional area, the inlet and outlet channels arranged in an alternating pattern, wherein the inlet channels are plugged at an outlet end of the honeycomb body, and the outlet channels are plugged at an inlet end of the honeycomb body.

5. The honeycomb body of claim 4, wherein the inlet cells have a hydraulic diameter 1.1-2 times greater than the outlet cells.

6. The honeycomb body of claim 1, wherein the honeycomb body is made of cordierite, aluminum titanate, or silicon carbide.

7. A honeycomb extrusion die comprising:
a die body having an inlet face and a discharge face opposite the inlet face;
a plurality of feedholes extending from the inlet face into the body;
an intersecting array of discharge slots extending into the body from the discharge face to connect with the feed holes at feed hole/slot intersections within the die body, the intersecting array of discharge slots defining a plurality of pins of two different cross-sectional areas, the plurality of pins forming a checkerboard matrix of pins alternating in cross-sectional area; and
wherein a width of the discharge slots increases along an axis extending to an outer periphery of the die.

8. The honeycomb extrusion die of claim 7, wherein the discharge face is divided into a first region including at least one row of pins adjacent the outer periphery of the die, and a second region including remaining pins; and wherein the width of discharge slots in the first region increases along an axis extending to the outer periphery of the die.

9. The honeycomb extrusion die of claim 8, wherein the first region includes at least four rows of pins adjacent the outer periphery of the die.

10. The honeycomb of claim 8, wherein the discharge slots in the first region have a width that is 1.01 to 4 times the width of discharge slots in the second region.

11. A method of manufacturing an extrusion die, the method comprising:
providing a die blank;
forming a die pattern having a plurality of intersecting discharge slots of uniform width in a face of the die blank by plunging a first EDM electrode into the die blank, wherein the intersecting discharge slots form side surfaces of a plurality of die pins having two different cross-sectional areas, the plurality of die pins forming a checkerboard matrix of pins alternating in size, wherein the die pattern is divided into a first region including the slots and pins adjacent the periphery of the die, and a second region including the remaining slots and pins in the die pattern; and
modifying the first region of the die pattern by plunging a second EDM electrode into the first region of the die pattern.

12. The method of claim 11, wherein modifying the first region of the die pattern comprises increasing the width of the discharge slots in the first region along an axis extending to the periphery of the die.

13. The method of claim 11, wherein modifying the first region of the die pattern comprises plunging the second EDM electrode at a plurality of plunge locations around the periphery of the die.

14. The method of claim 13, wherein the second EDM electrode comprises a ¼ pattern of the first region, and wherein plunging the second EDM electrode at a plurality of plunge locations around the periphery of the die comprises plunging the second EDM electrode consecutively at each quarter section of the first region.

15. The method of claim 14, wherein for each consecutive plunge location the second EDM electrode is offset at least one pin row from a previous plunge location.

16. The method of claim 11, wherein the second EDM electrode has a shape that is complementary to a peripheral shape of the die.

17. The method of claim 16, wherein the second EDM electrode has a shape that is complementary to a fraction of the peripheral shape of the die.

18. The method of claim 17, wherein the second EDM electrode has a shape that is complementary to ¼ of the peripheral shape of the die.

19. The method of claim 11, wherein the first region includes at least one row of slots and pins adjacent the periphery of the die.

20. The method of claim 11, wherein the first region includes at least four rows of slots and pins adjacent the periphery of the die
